(19) United States
(12) Patent Application Publication
(10) Pub. No.: US 2010/0162299 A1
(43) Pub. Date: Jun. 24, 2010

(54) SYSTEM AND METHOD FOR DELIVERING VIDEO-ON-DEMAND (VOD) CONTENT DURING EMERGENCY ALERT SYSTEM (EAS) EVENTS

(75) Inventor: William S. Downey, Franklin, MA (US)

Correspondence Address: VERIZON;PATENT MANAGEMENT GROUP, 1320 North Court House Road, 9th Floor, ARLINGTON, VA, 22201-2909, US

(73) Assignee: Verizon Corporate Services Group Inc., Basking Ridge, NJ (US)

(21) Appl. No.: 12/339,137

(22) Filed: Dec. 19, 2008

(51) Int. Cl. H04N 7/025; H04N 7/173; H04N 5/44

(52) U.S. Cl. 725/33; 725/91; 725/100; 348/734

(57) ABSTRACT

A system and method for delivering VOD content during emergency alert system events including receiving a request for a programming session at VOD system and transmitting the requested programming content from the VOD system. Also, the system and method may include transmitting one or more emergency alert system messages from an emergency alert system, and receiving one or more sustain messages at the VOD system and in response the VOD system continually providing the requested programming content during the one or more emergency alert system messages based at least in part on the one or more sustain messages.

### BACKGROUND INFORMATION

Due to advances in technology, television-watching has evolved into a multimedia experience. For example, viewers may now watch TV in high-definition on a large flat-screen with stereo surround sound in the comfort of their homes. Also, viewers are now able to select a video-on-demand (VOD) content from an ever increasing variety of TV content which may cater specifically to the preferences of each viewer. However, the VOD services may have limited capacity to manage an emergency alert system (EAS) event. For example, during an EAS event, a VOD session may be terminated in order to broadcast an EAS message. For example, a large number of viewers may receive the EAS message, and in response may cause VOD servers to be inundated with VOD termination message provided by the viewers systems receiving the EAS message. Also, at the termination of the EAS message, all viewers receiving the EAS messages may attempt to reestablish a connection with the VOD servers by providing a VOD initiation message. Therefore, an influx of VOD termination messages and/or VOD initiation messages may overwhelm the VOD servers and may affect a request (e.g., Start, Stop, Rewind, Forward, Pause) of VOD content by viewers unaffected by the EAS event. In addition, in the event that during one or more attempts of reestablish a connection, viewers may fail to reestablish a connection with the VOD servers, the viewers may provide multiple subsequent VOD initiation messages in order to reestablish a connection with the VOD servers. Therefore, the multiple subsequent VOD initiation messages provided by the viewers may place additional burden on the VOD servers and may cause delay in transmission of the VOD content.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 illustrates an exemplary system for delivering VOD content during an EAS event, according to an embodiment;

FIG. 2 illustrates a detailed exemplary system for delivering VOD content during an EAS event, according to an embodiment;

FIGS. 3 illustrates a flowchart of a method for delivering VOD content during an EAS event, according to an exemplary embodiment; and

FIG. 4 illustrates a remote control device for an exemplary system for delivering VOD content during an EAS event, according to an embodiment.

These and other embodiments and advantages will become apparent from the following detailed description, taken in conjunction with the accompanying drawings, illustrating by way of example the principles of the various exemplary embodiments.

### DETAILED DESCRIPTION OF EMBODIMENTS

An exemplary embodiment provides a system and method for delivering VOD content during EAS events. The VOD content delivering system may deliver the VOD content to one or more viewers via a network during a VOD session. A set-top box associated with the viewers may receive the VOD content and display the VOD content to the viewers via a display device. In the event that an EAS event occurs, an EAS may provide EAS messages (e.g., MPEG packets via society of cable telecommunications engineers (SCTE) 18 standard) to the set-top box. The set-top box may tune to channel(s) associated with EAS events and display the EAS messages. For example, the set-top box may receive the EAS messages and display the EAS messages to the viewers via the display device. For the duration of the EAS messages, the set-top box may transmit one or more sustain signals (e.g., a plurality of packets of information) to the VOD system in order to continue the VOD session. The set-top box may discard the VOD content for the duration of the EAS messages. Also, the set-top box may include one or more databases to store VOD content for the duration of the EAS messages. The set-top box may display the VOD content and the EAS messages simultaneously to the user (e.g., picture within picture or on a scroll bar). At the termination of the EAS message, the viewers may access the VOD content for the duration of the EAS messages via the VOD system and/or the database of the set-top box.

The description below describes a VOD system, an EAS, a set-top box, a display device and/or other elements for delivering VOD content and/or EAS messages that may include one or more modules, some of which are explicitly depicted, others of which are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, etc.) separately. The functions described as being performed at various components may be performed at other components, and the various components may be combined and/or separated. Other modifications also may be made.

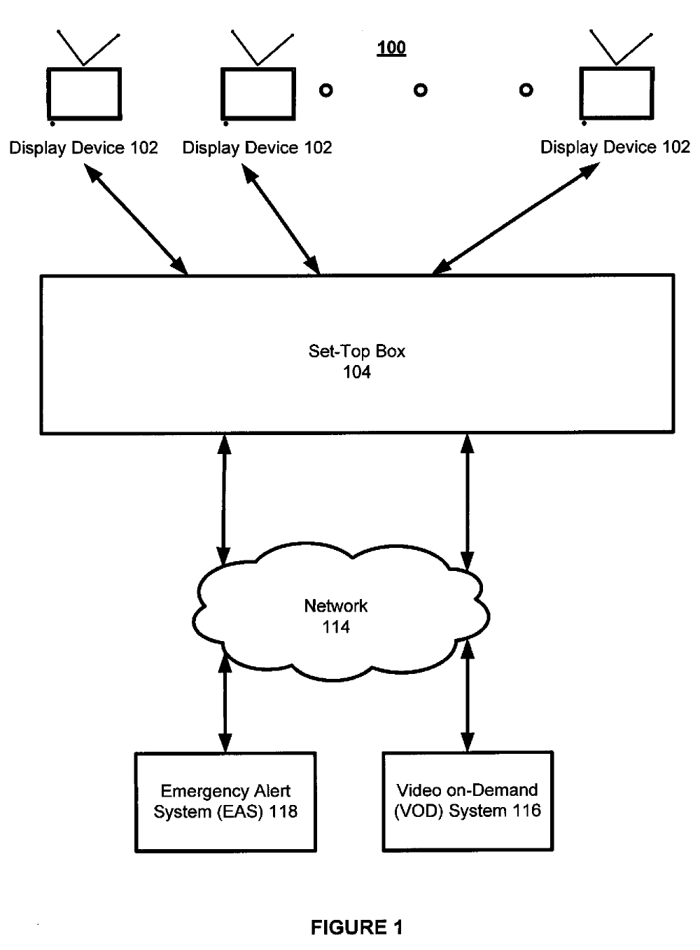

FIG. 1 is a system 100 for delivering VOD content during EAS events, according to an exemplary embodiment. As illustrated, one or more display devices 102 may be communicatively coupled to a set-top box 104. The set-top box 104 may be communicatively coupled to a video on-demand (VOD) system 116 and/or an EAS 118 via a network 114. The VOD system 116 may provide VOD content to the set-top box 104 and the set-top box 104 may display the VOD content to one or more viewers via the display devices 102. The EAS 118 may provide one or more EAS messages to the set-top box 104 during EAS events. The set-top box 104 may display the EAS messages to the viewers via the display devices 102. In an exemplary embodiment, during the EAS messages, the set-top box 104 may transmit one or more sustain signals (e.g., a plurality of packets of information) to the VOD system 116 in order to maintain the VOD session, therefore, the video-on-demand session may not be terminated and/or reestablished due to the EAS messages.

Also for example, the viewers may select VOD content and/or a channel associated with the VOD content via the set-top box 104. The viewers may provide a request for the VOD content to the set-top box 104. The set-top box 104 may provide the request for the VOD content to the VOD system 116 via the network 114. The VOD system 116 may provide the requested VOD content to the set-top box 104 via the network 114. The set-top box 104 may provide the requested VOD content to the display device 102 and may be displayed to the one or more viewers.

In addition, during EAS events, the EAS 118 may provide one or more EAS messages to the set-top box 104. For example, the EAS event may include, natural or man-made emergencies including, but not limited to, hurricanes, meteor strikes, ice storms, tornadoes, earthquakes, unforeseen catastrophic events, terrorist/criminal attacks, and combinations thereof. The EAS messages provided to the set-top box 104 may be warnings, advisories, and/or other messages to the viewers and may be displayed via the one or more display devices 102. In an exemplary embodiment, the EAS messages may cause the set-top box 104 to automatically display the EAS messages.

The display device 102 may display VOD content and/or EAS messages. The display device 102 may be a television set, for example. The display device 102 also may be other devices capable for displaying video, such as, but not limited to, computer monitor, liquid crystal display (LCD), cathode ray tube (CRT), rear projection television (RPTV), flat panel television, plasma display, surface-conduction electron-emitter display (SED), video projector, light-emitting diode, organic light-emitting diode (OLED) and/or other similar display devices for displaying television content. Also, the display device 102 may include, but not limited to, a computer, a personal computer, a laptop, a cellular communication device, a workstation, a mobile device, a phone, a handheld PC, a personal digital assistant (PDA), a thin system, a fat system, a network appliance, an Internet browser, a paging, an alert device, and/or other any other device for displaying television content.

The set-top box 104 may be an integrated receiver/decoder (IRD) device and/or a small computer that may communicatively couple the user display device 102 to the VOD system 116 and/or the EAS 118. The set-top box 104 may receive an external signal and couple the external signal to the display device 102. In an exemplary embodiment, the set-top box 104 may be communicatively coupled to, integrated and/or associated with the display device 102. The set-top box 104 may be a digital video recorder, a set top box, a converter, a cable card, and/or other device capable of coupling an external signal source to the display device 102 The set-top box 104 may communicatively couple an external signal source from an Ethernet cable, a satellite dish, a coaxial cable, a telephone line, a broadband over power line, a very high frequency antenna, ultra high frequency antenna and/or other external signal source to transmit a signal to the display device 102. The set-top box 104 and the display device 102 also may be a single device, instead of two separate devices, as shown.

The network 114 may be a wireless network, a wired network or any combination of thereof that may couple the set-top box 104 and the VOD system 116 and/or the EAS 118. The network 114 may be a communication network to enable an Internet protocol (IP) content (e.g., video on-demand content and/or EAS messages) having real-time streaming protocol (RTSP) capabilities. For example, the network 114 may include, without limitation, telephone line, fiber optics, IEEE Ethernet 802.3, wide area network (WAN), local area network (LAN), global network such as the Internet. Also, the network 114 may include, but is not limited to, wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or other wireless network for deliver content and enable communication between the VOD system 116 and/or the EAS 118 with the set-top box 104. In addition, network 114 may enable, a wireless communication network, a cellular network, an Intranet, or the like, or any combination thereof The network 114 may include, but is not limited to, multimedia over COAX Alliance (MOCA), quadrature amplitude modulation (QAM), phase-shift keying (PSK) modulation, hybrid fibre-coaxial (HFC), and/or other transmission networks for cable plants and/or fiber optic services. The network 114 may further include one, or any number of the exemplary types of networks mentioned above operating as a stand-alone network or in cooperation with each other.

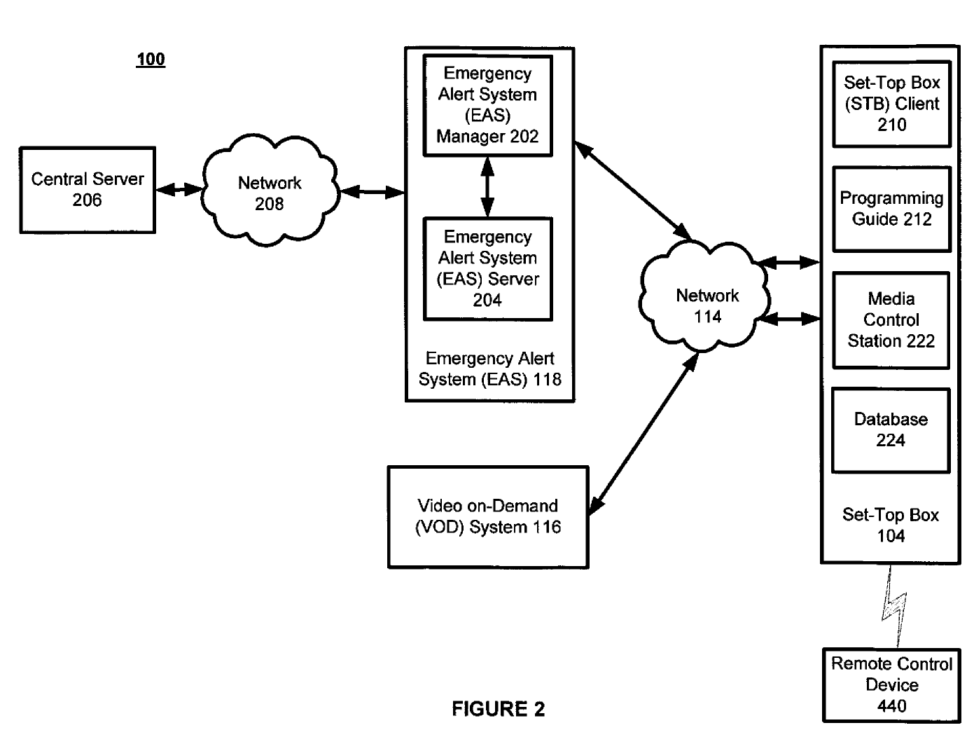

FIG. 2 illustrates a detailed view of the system 100 for delivering VOD content during EAS events, according to an exemplary embodiment. As discussed above, also the EAS 118 may be communicatively coupled to the set-top box 104 via the network 114. As illustrated in FIG. 2, the set-top box 104 may include a set-top box client 210, a programming guide 212, a media control station 222, and/or a database 224. The EAS 118 may be coupled to a central server 206 via network 208. For example, the network 208 may be similar to the network 114. The EAS 118 may include an EAS manager 202 and/or an EAS server 204.

The central server 206 may provide EAS messages to the EAS server 204 via network 208 during the EAS events. The EAS messages may be warnings, advisories, and/or other messages that inform viewers of EAS events (e.g., natural disasters as described above). For example, the central server 206 may include, but not limited to, service providers, enterprises, educational institutions, government agencies, and any individual, group and/or organization running, maintaining and/or providing EAS messages. The government agencies may include, but are not limited to, National Oceanic and Atmospheric Administration (NOAA), Department of Homeland Security (DOH), and/or other government agencies that may provide warnings and/or advisories.

The EAS server 204 may provide the EAS messages (e.g., MPEG packets via society of cable telecommunications engineers (SCTE) 18 standard) to the one or more viewers via the set-top box 104. In another embodiment, the EAS server 204 may provide the EAS messages (e.g., MPEG packets via quadrature phase-shift keying (QPSK) modulation) to the one or more viewers via the set-top box 104. For example, the EAS server 204 may replicate the EAS messages and provide copies of the replicated EAS messages to one or more affected viewers. For example, in case of EAS events, the central server 206 may provide EAS messages to the EAS server 204. Thereafter, the EAS server 204 may provide the EAS messages to one or more affected viewers via the set-top box 104 associated with the one or more affected viewers.

In an exemplary embodiment, before the EAS server 204 may provide the EAS messages to the one or more affected viewers, the EAS manager 202 may determine a mapping (e.g., assigning a channel and/or time slot) associated with the EAS messages provided by the central server 206 to the EAS server 204. The EAS manager 202 may be a computer readable storage media including code to control a function of the EAS 118, the set-top box client 210, the programming guide 212, and/or the media control station 222. The EAS manager 202 may associate a channel and/or a time slot with the EAS messages. For example, the EAS manager 202 may display EAS messages on channel 800 at 12 a.m. to 11:59 a.m. and/or channel 900 at 12 p.m. to 11:59 p.m. Also, the EAS manager 202 may be in communication with the programming guide 212. The mapping information associated with the EAS messages may be provided to the programming guide 212 by the EAS manager 202 to be displayed to the one or more viewers.

In addition, the EAS manager 202 may associate identification information with the EAS messages. For example, the EAS manager 202 may associate a uniform resource locator (URL) to the EAS messages. Also, the EAS manager 202 may associate an EAS message name, EAS message time and/or other identification information for identifying EAS messages.

Further, the EAS manager 202 may determine a storage time, buffer time and/or live feed associated with the EAS messages. The EAS manager 202 may determine a storage time associated with the EAS messages and/or an archive time of the EAS messages. Also, the EAS manager 202 may determine a time delay and/or a buffer time associated with each EAS message. Further, the EAS manager 202 may determine a live feed associated with each EAS message. Furthermore, the EAS manager 202 may determine a reception associated with an EAS message from the central server 206 to the EAS server 204. For example, the EAS manager 202 may determine a storage time and/or a buffer time of an EAS message upon reception of such EAS message.

The set-top box 104 may tune (e.g., channel override and/or force-tune) a channel associated with the VOD system 116 and/or the EAS 118. For example, one or more viewers may tune to a channel and request a VOD session from the VOD system 116 to start a VOD session. For example, one or more viewers may request VOD content, for example, a movie and/or a television program from a VOD session (e.g., Iron Man movie and/or a sporting event). The VOD system 116 may provide the requested movie and/or television program to the one or more viewers.

In an exemplary embodiment, during a VOD session, the set-top box 104 may receive one or more EAS messages from the EAS 118. For example, the set-top box client 210 may receive one or more EAS messages from the EAS server 204. The set-top box client 210 may automatically tune to a channel associated with displaying the EAS messages provided by the EAS 118. For example, the set-top box client 210 may tune to channel 800 in order to display the EAS messages (e.g., tornado advisory) to the viewers. In an exemplary embodiment, the set-top box client 210 may receive one or more EAS messages from the EAS server 204 during a VOD session. The set-top box client 210 may interrupt the VOD session and automatically tune to an EAS channel (e.g., channel 800) in order to display the EAS messages (e.g., ice storm) to the viewer via the display device 102. The set-top box client 210 may tune to the EAS channel (e.g., channel 800) for a period of time (e.g., several minutes) in order to display the EAS messages. At the termination of the EAS messages, the set-top box client 210 may tune back to the channel (e.g., a transmission control protocol (TCP) and/or Internet protocol (IP) stream) associated with the interrupted VOD session.

In an exemplary embodiment, the set-top box client 210 may receive EAS messages from the EAS 118 and may tune to an EAS channel (e.g., a transmission control protocol (TCP) and/or Internet protocol (IP) stream) associated with displaying the EAS messages. In other embodiments, the set-top box client 210 may receive EAS messages from the EAS 118 and display the EAS messages (e.g., channel override and/or force-tune) over the VOD content. The set-top box 104 may display the EAS message to the viewer via the display device 102. For the duration of the EAS messages, the set-top box client 210 may provide one or more sustain messages (e.g., including packets of information) to the VOD system 116 in order to maintain the VOD session. In an exemplary embodiment, the set-top box client 210 may provide a sustain message (e.g., Keep-Alive message) to the VOD system 116 upon the reception of the EAS messages from the emergency alert system server 204. Also, the set-top box client 210 may provide one or more sustain messages to the VOD system 116 for the duration of an EAS message. The set-top box client 210 may provide the one or more sustain messages to the VOD system 116 continuously or intermittently for the duration of each EAS message.

For example, the VOD system 116 may continue to provide the VOD content to the set-top box 104 upon reception of the sustain message provided by the set-top box client 210 during the EAS messages. For example, the set-top box 104 may discard the VOD content provided by the VOD system 116 during the EAS messages. At the termination of the EAS message, the viewers may provide a request (e.g., rewind the VOD content) to the VOD system 116 in order to return to the VOD session where the viewers left off (e.g., at a point where the EAS messages started). In another exemplary embodiment, the VOD content provided by the VOD system 116 during the EAS messages may be stored at the database 224. At the termination of the EAS messages, the viewers may access the VOD content during the EAS messages via the database 224. In other exemplary embodiments, the set-top box 104 may simultaneously display the VOD content provided by the VOD system 116 and the EAS messages provided by the EAS 118 to the user via the display devices 102. In an exemplary embodiment, the set-top box 104 may provide the EAS message in a main window of the display device 102 and the VOD content in an auxiliary window of the display device 102. Also, the set-top box 104 may provide the EAS message as a banner on a portion of the display devices 102.

In an exemplary embodiment, the set-top box client 210 may provide an initiation messages (e.g., one or more control signals) to the VOD system 116 in order to start a VOD session. Also, the set-top box client 210 may provide one or more sustain messages to the VOD system 116 in order to maintain the VOD session. The set-top box client 210 may provide the one or more sustain messages to the VOD system 116 continuously or intermittently. In addition, the set-top box client 210 may provide a termination message to the VOD system 116 in order to terminate the VOD session.

The programming guide 212 may provide an electronic program guide (EPG), an interactive program guide (IPG), and/or an electronic service guide (ESG) in order to inform viewers of scheduled broadcast television programs. For example, the programming guide 212 may provide a television program guide channel that may provide schedule information associated with television programs. The programming guide 212 may provide the schedule information associated with television programs for one or more time slots of the day or 24 hours a day.

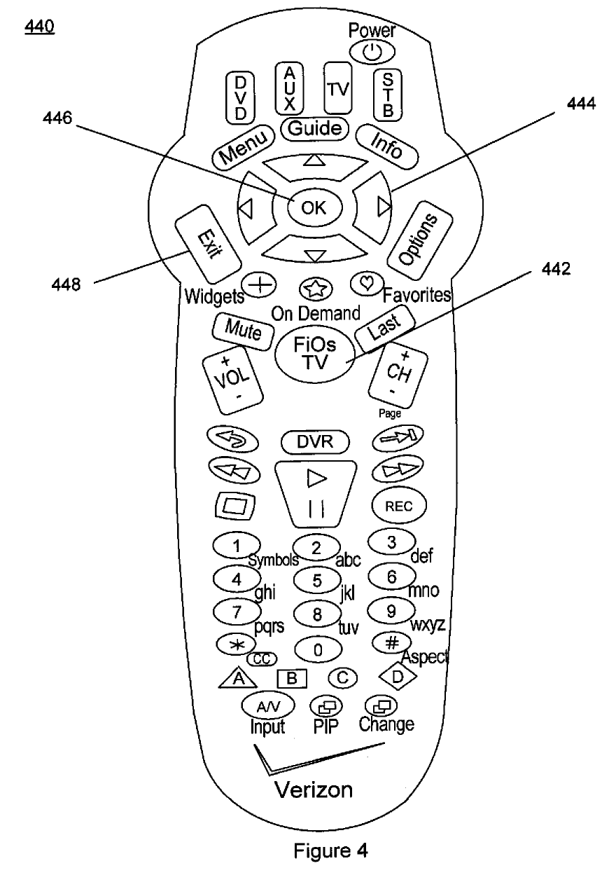

The media control station 322 may include a receiver to receive one or more commands/signals from a remote control device 440 (e.g., shown in FIG. 4) and/or receive one or more media signals (e.g., streaming media, television programs) from the video on-demand system 116 and/or the EAS system 118. The set-top box client 210 may receive one or more command/signals from the media control station 322 and/or transmit/receive one or more medial signals (e.g., VOD content) to the VOD system 116.

The remote control device 440 (e.g., shown in FIG. 4) may transmit to and/or receive signals from the set-top box 104. The remote control device 440 may include, for example, a display graphical user interface command 442, one or more navigation commands 444, a selection command 446, and an exit command 448. The exit command 448 may communicate a termination identifier to exit out of a display of a graphical user interface, the display graphical user interface command 442 may instruct the set-top box 104 to display a graphical user interface (e.g., programming guide), the one or more navigation commands 444 may be arrows for scrolling through and highlighting various fields of a graphical user interface, and the selection command 446 may select a particular field within the graphical user interface. It is noted that the remote control device 440 is depicted as being a remote control with keys that may be pressed by a user. The remote control device 440 also may include a touch-screen where the viewer may touch an icon on a display (e.g., on display device 102). Other input devices also may be used, such as, but not limited to, voice activated or gesture activated input devices.

Signal transmission by the remote control device 440 may include a variety of wireless signaling pathways, such as infrared, Bluetooth™, local area wireless network (e.g., 802.11 based protocols), and/or other similar signaling applications for communication between the remote control device 440 and the set-top box 104 or other similar devices. Other various embodiments may also be provided.

It should be appreciated by one of ordinary skill in the art that the remote control device 440 may come in a variety of shapes, sizes, textures, and functionalities with an assortment of buttons and/or labels. Additionally, the remote control device 440 may use various technologies (e.g., wired or wireless technologies) to communicate with external devices. Furthermore, the remote control device 440 may include various playback features, alphanumeric entries/buttons, and other similar functions. It should also be appreciated that other devices having alphanumeric and/or similar remote control capabilities may be used as remote control devices as well. These may include desktop computers, laptops, game controllers, mobile communication devices, such as personal digital assistants (PDAs), mobile phones, smart phones, as well as other devices that may transmit and/or receive signals to/from the set-top box 104. In other embodiments, the display devices 102 and/or the set-top box 104 may operate without the remote control device 440. For example, the display devices 102 and/or the set-top box 104 may include one or more buttons to control the functions of the display devices 102 and/or the set-top box 104.

The database 224 may store relevant information received from the VOD system 116 and/or the EAS 118. Exemplary database information may include network provider information, TV program channel numbers, TV program channel names, program listings, program schedules for each of the programs, future and past program content information, ratings, viewer preferences, advertisement categories, advertisers, advertised product/service, and/or other information provided by one or more viewers or the VOD system 116, the EAS 118 or storage source (e.g., pre-recorded TV programs/movies). Although database 224 is shown as a single database, it should be appreciated that the contents of the database 224 may be stored into a plurality of databases and may be stored on one or more data storage systems and/or servers. Furthermore, the database 224 may be local, remote, or a combination thereof to the set-top box 104. For example, the database 224 may be a component integrated with the set-top box 104. Also, the database 224 may be a disparate database communicatively coupled to the set-top box 104. Additionally, the database 324 may also store relevant information for personalized subscriber services. These may include user/viewer channel preferences, preferred TV programs/channels, preferred TV viewing times, and other preferred or customized information. Such information may be useful in providing additional customizations for enhanced TV-viewing experience. Other variations may also be provided.

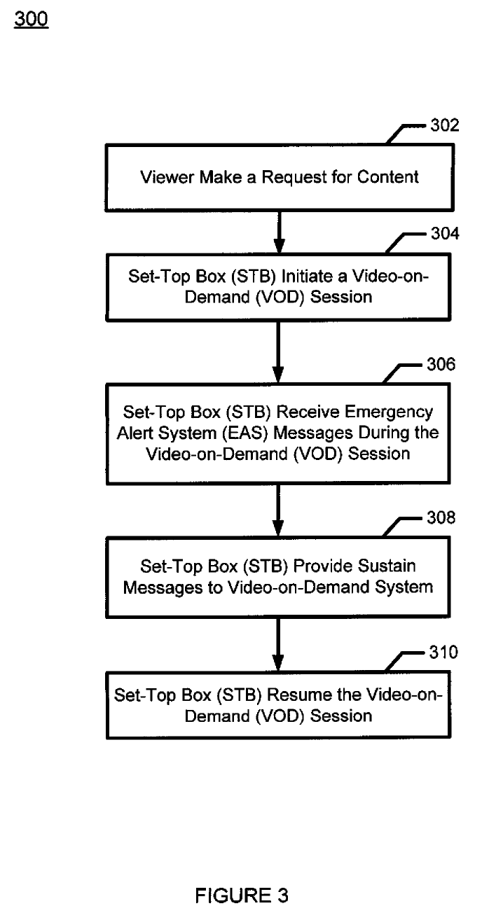

FIG. 3 illustrates a flow diagram of a method 300 for delivering video-on-demand (VOD) content during emergency alert system (EAS) events, in accordance with exemplary embodiment. This exemplary method 300 may be provided by way of example, as there are a variety of ways to carry out the method. The method 300 shown in FIG. 3 can be executed or otherwise performed by one or a combination of various systems. The method 300 is described below may be carried out by the system 100 shown in FIGS. 1 and 2, by way of example, and various elements of the delivery system 100 are referenced in explaining the example method of FIG. 3. Each block shown in FIG. 3 represents one or more processes, methods or subroutines carried out in exemplary method 300. Referring to FIG. 3, exemplary method 300 may begin at block 302.

At block 302, one or more viewers may make a request for VOD content. For example, one or more viewers may use a remote control device 440 and/or buttons associated with the display device 102 and/or the set-top box 104 to request for VOD content. A programming guide 212 may provide the one or more viewers a channel and/or time slot associated with the VOD content. Also, the programming guide 212 may provide the one or more viewers a brief description of the VOD content and/or other information associated with identifying the VOD content. The one or more viewers may use the remote control device 440 to provide a request signal associated with identification information of the content to a set-top box 104. Further, one or more viewers may input a request for content via an input module (not shown e.g., keypad) associated with the set-top box 104. After the one or more viewers makes a request for content, the method 300 may proceed to block 304.

At block 304, the set-top box 104 may initiate a VOD session. For example, the media control station 322 may determine the viewers requested VOD content. The set-top box 104 may provide a request for VOD content to the VOD system 116 via network 114 based at least in part on the requested signal for the video-on-demand content. The VOD system 116 may provide the requested content to the set-top box 104 to display to the one or more viewers via a display device 102. For example, the set-top box client 210 may initiate a VOD session by providing the request to the VOD system 116. Upon reception of the initiation message at the VOD system 116, the VOD system 116 may provide VOD content to the set-top box client 210. Also, the set-top box client 210 may provide information associated with initiating the VOD session to the VOD system 116. After the set-top box 104 may initiate a VOD session, the method 300 may proceed to block 306.

At block 306, the set-top box 104 may receive EAS messages during the VOD session. For example, a central server 206 may provide EAS messages to the EAS 118 via a network 208. The central server 206 may provide the EAS messages to the EAS server 204. The EAS server 204 may provide the EAS messages to the set-top box 104 associated with one or more affected viewers. Also, the EAS manager 202 may provide the set-top box client 210 information associated with EAS messages. The EAS manager 202 may determine a mapping associated with the EAS messages provided by the central server 206 to the EAS server 204. The set-top box client 210 may receive the EAS messages from the EAS server 204 and display the EAS message to the viewers via the display devices 102. After the set-top box 104 may receive EAS messages during the VOD session, the method 300 may proceed to block 308.

At block 308, the set-top box 104 may provide one or more sustain messages (e.g., Keep-Alive messages) to the VOD system 116 in order to maintain the VOD session. For example, the set-top box client 210 may provide one or more sustain messages to the VOD system 116 in order to maintain the VOD session. The set-top box client 210 may provide the one or more sustain messages to the VOD system 116 continuously or intermittently. The VOD content received during the EAS message may be discarded by the set-top box 104. Also, the VOD content received during the EAS message may be stored in a database 224 of the set-top box 104. In other embodiments, the VOD content received during the EAS message may be simultaneously displayed with the EAS message to the viewers via the display devices 102. After the set-top box 104 provides the one or more sustain messages to the VOD system 116 in order to maintain the VOD session, the method 300 may proceed to block 310.

At block 310, the set-top box 104 may resume the VOD session. For example, at the termination of the EAS message, the viewers may rewind the VOD session to at the beginning of the EAS message. For example, the viewers may provide a request to the VOD system 116 in order to rewind the VOD session to at the beginning of the EAS message. Also, the viewers may provide a request to the set-top box 104 (e.g., database 224) in order to rewind the VOD session to at the beginning of the EAS message. Also, the viewers may access the database 224 of the set-top box 104 in order to access the VOD content during the EAS messages.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
receiving one or more requests for a programming session at a video-on-demand system;
transmitting the requested programming content from the video-on-demand system to one or more set-top boxes associated with the one or more requests;
transmitting one or more emergency alert system messages to the one or more set-top boxes, wherein the one or more emergency alert system messages is from an emergency alert system; and
receiving one or more sustain messages at the video-on-demand system from at least one of the one or more set-top boxes and in response, the video-on-demand system continually providing the requested programming content during the one or more emergency alert system messages based at least in part on the one or more sustain messages.

2. The method of claim 1, further comprises receiving the one or more emergency alert system messages from a central server.

3. The method of claim 2, wherein the central server comprises at least one of service providers, enterprises, educational institutions, and government agencies.

4. The method of claim 1, wherein the one or more emergency alert system messages includes at least one of warnings and advisories associated with at least one of natural and man-made emergencies.

5. The method of claim 1, wherein transmitting the requested programming content simultaneously to transmitting the one or more emergency alert system messages.

6. The method of claim 1, further comprises the one or more set-top boxes tuning to a channel associated with the programming content at termination of the one or more emergency alert system messages.

7. The method of claim 1, wherein receiving one or more sustain messages at the video-on-demand system from the at least one of the one or more set-top boxes comprises receiving the one or more sustain messages from the one or more set-top box intermittently or continuously.

8. The method of claim 1, further comprises transmitting the programming content during the one or more emergency alert system messages to at least one viewer via the one or more set-top boxes.

9. A computer readable storage media comprising code to perform the acts of the method of claim 1.

10. A method, comprising:
receiving, at a set-top box, a request from a viewer;
transmitting, from the set-top box, the request to a video-on-demand system, receiving, at the set-top box, programming content based at least in part on the request from the video-on-demand system;
receiving, at the set-top box, one or more emergency alert system messages from an emergency alert system;
transmitting, from the set-top box, one or more sustain messages to the video-on-demand system and continuously receive the programming content during the one or more emergency alert system messages based at least in part on the one or more sustain messages; and
displaying the one or more emergency alert system messages via a display device communicatively coupled to the set-top box.

11. The method of claim 10, wherein receiving a request from a viewer comprises receiving the request from remote control device.

12. The method of claim 10, wherein receiving one or more emergency alert system messages from an emergency alert system comprises receiving the one or more emergency alert system messages during the reception of the programming content.

13. The method of claim 10, wherein transmitting one or more sustain messages comprises transmitting the one or more sustain messages based at least in part on the reception of the one or more emergency alert system messages.

14. The method of claim 10, wherein transmitting one or more sustain messages comprises transmitting the one or more sustain messages intermittently or continuously.

15. The method of claim 10, further comprises tuning to an emergency alert system channel based at least in part on the reception of the one or more emergency alert system messages.

16. The method of claims 10, further comprises displaying the programming content and the one or more emergency alert system messages simultaneously via the display device.

17. The method of claim 10, further comprises discarding the received programming content during the one or more emergency alert system messages based at least in part on the one or more sustain messages.

18. The method of claim 10, further comprises storing the received programming content in a database during the one or more emergency alert system messages based at least in part on the one or more sustain messages.

19. The method of claim 18, further comprises providing the stored programming content to the viewer via the display device.

20. A computer readable storage media comprising code to perform the acts of the method of claim 10.

21. A system, comprising:
an emergency alert system configured to provide one or more emergency alert system messages to a set-top box from a central server; and
a video-on-demand system configured to provide a programming content during the one or more emergency alert system messages based at least in part on one or more sustain messages provided by the set-top box.
